(19) United States
(12) Patent Application Publication
(10) Pub. No.: US 2001/0033910 A1
(43) Pub. Date: Oct. 25, 2001

(54) Ceramic honeycomb structure

(75) Inventor: Koichi Ikeshima, Okazaki-city (JP)

Correspondence Address: PARKHURST & WENDEL, L.L.P., Suite 210, 1421 Prince Street, Alexandria, VA, 22314-2805, US

(73) Assignee: NGK INSULATORS, LTD.

(21) Appl. No.: 09/803,941

(22) Filed: Mar. 13, 2001

(30) Foreign Application Priority Data
Mar. 14, 2000 (JP) 2000-070250

(51) Int. Cl. B32B 3/12; B01J 32/00

(52) U.S. Cl. 428/116; 502/527.19

(57) ABSTRACT

A ceramic honeycomb structure includes a plurality of through-holes surrounded by partition walls, wherein a thermal expansion coefficient of an outer circumferential wall portion in the ceramic honeycomb structure is larger than a thermal expansion coefficient in a direction of a diameter of an inside partition wall portion 5 in the ceramic honeycomb structure, and stress is applied to the inside partition wall portion from the outer circumferential wall portion. An outer circumferential wall portion of the ceramic honeycomb structure is reinforced, and the ceramic honeycomb structure does not hinder a flow of gas in a circumferential partition wall portion of the ceramic honeycomb structure, and thermal shock resistance of the ceramic honeycomb structure is enhanced profitably.

### BACKGROUND OF THE INVENTION AND RELATED ART STATEMENT

The present invention relates to a ceramic honeycomb structure having a processed outer circumference. In particular, the present invention relates to a ceramic honeycomb structure whose outer circumference wall portion is reinforced, which does not hinder a gas flow through partition walls in an outer circumferential portion of the ceramic honeycomb structure, and whose thermal shock resistance is enhanced.

ceramic honeycomb structure is broadly used as a substrate of a catalyst for purifying automobile exhaust gas because of its light weight and small resistance upon gas passage. About a shape of a cell, a square cell is employed because of easiness of production of a die for forming and high mechanical strength. As a material, a cordierite material whose thermal shock resistance becomes high because of its small thermal expansion coefficient is generally employed. In addition, as a forming method, the extrusion forming is employed generally because mass production is possible with the method. In recent years, high performance of a catalyst has been expected due to the necessity of improving purification performance of automobile exhaust gas, and production of a ceramic honeycomb structure having light weight and high surface area has been expected.

However, it is generally difficult to produce the ceramic honeycomb structure having a thickness of a partition wall of 0.1 mm or less and 62 cells/cm², or an open frontal area of 86% or more, or a bulk density of 0.26 g/cm³ or less; and partition walls near the outer circumferential wall portion are deformed mainly at the stage of extrusion forming and damaged easily by pressure from circumference and a thermal shock. Therefore, there is a problem that utility and durability as a part for purifying automobile exhaust gas will be lost.

Japanese Patent Laid-Open No. 57-99340 discloses a ceramic honeycomb structure whose thermal expansion coefficient is increased from the center toward an outside surface. However, if a thermal expansion coefficient of an inside partition wall portion is increased, it has the disadvantage of being damaged even by a weak thermal shock.

In addition, the Japanese Patent Laid-Open No. 57-99340 discloses a method to apply a ceramic material such as silica and alumina on partition walls of a ceramic honeycomb structure. However, according to this method, because a great deal of material which raises a thermal expansion coefficient is applied on partition walls of the outer circumferential portion, the inner diameter of a cell becomes smaller on partition walls of a circumferential portion, and a pressure drop increases, too. Therefore, there are problems that a gas flow through partition walls in the outer circumferential portion is remarkably decreased, and the whole catalyst cannot be effectively taken advantage of, thereby purification performance falls.

Incidentally, a general method to carry a catalyst on a ceramic honeycomb structure is a technique where γ-alumina having a large specific surface area is first turned into a water solution to be carried on a ceramic honeycomb structure and a noble metal catalyst is carried on the solution. If a ceramic material such as silica and alumina which raises a thermal expansion coefficient is applied to the partition walls at this time, the more a quantity of the application is, the more the water absorption ratio falls, which cause a problem that a ceramic honeycomb structure cannot carry γ-alumina uniformly, that is, a catalyst cannot be dispersed uniformly.

Further, Japanese Patent Laid-Open No. 56-129044 discloses a ceramic honeycomb structure having a high thermal expansion coefficient in an inside partition wall portion and a small coating thermal expansion of partition walls in an outer circumferential portion. However, a cordierite honeycomb structure in general use at present for automobile exhaust gas purification is produced by taking advantage of a technique to raise thermal shock resistance by making a thermal expansion coefficient as a structure small by orienting a raw material by extrusion forming. Therefore, there is no ceramic material having a smaller thermal expansion coefficient than the cordierite produced through extrusion forming, and the technique cannot be applied to a honeycomb structure whose main material is cordierite.

### SUMMARY OF THE INVENTION

The present invention has been made in view of such problems of prior art and aims to provide a ceramic honeycomb structure whose outer circumferential wall portion is reinforced, which does not hinder a flow of gas in a circumferential partition wall portion of the ceramic honeycomb structure, and whose thermal shock resistance is enhanced profitably.

That is, according to the present invention, there is provided a ceramic honeycomb structure having a plurality of through-holes surrounded by partition walls, wherein a thermal expansion coefficient of an outer circumferential wall portion in the ceramic honeycomb structure is larger than a thermal expansion coefficient of an inside partition wall portion in a direction of a diameter of the ceramic honeycomb structure, and stress is applied to the inside partition wall portion from the outer circumferential wall portion.

In the present invention, it is preferable that a material for the outer circumferential wall portion of the ceramic honeycomb structure is the same as or different from a material for the ceramic honeycomb structure.

In the present invention, it is preferable that a partition wall of the ceramic honeycomb structure has a thickness of less than 0.1 mm and that the ceramic honeycomb structure has 62 cells/cm² or more.

In the present invention, it is preferable that the outer circumferential wall portion is thicker than an inside partition wall portion of the ceramic honeycomb structure.

In addition, in the present invention, it is preferable that the ceramic honeycomb structure has an open frontal area of 86% or more.

In addition, in the present invention, it is preferable that the ceramic honeycomb structure has a bulk density of 0.26 g/cm³ or less.

### BRIEF DESCRIPTION OF THE DRAWINGS

FIG. 1(a)(b) are schematic views describing one embodiment of the ceramic honeycomb structure whose outer circumferential wall portion was reinforced with a slurried raw material in the present invention, and FIG. 1(a) is a perspective view of the whole, and FIG. 1(b) is an enlarged view around the reinforceed outer circumferential wall portion.

FIG. 2(a)(b) show one embodiment of a ceramic honeycomb structure subjected to a reinforcement process with a slurried raw materials after the outer circumferential portion partition walls and the outer circumferential wall portion were ground to be removed in the present invention, and FIG. 2(a) is a perspective diagram of the whole, and FIG. 2(b) is an enlarged view around the reinforced outer circumferential wall portion.

### DETAILED DESCRIPTION OF THE INVENTION

The present invention is hereinbelow described in detail based on embodiments shown in the drawing, but the present invention is by no means limited to these embodiments.

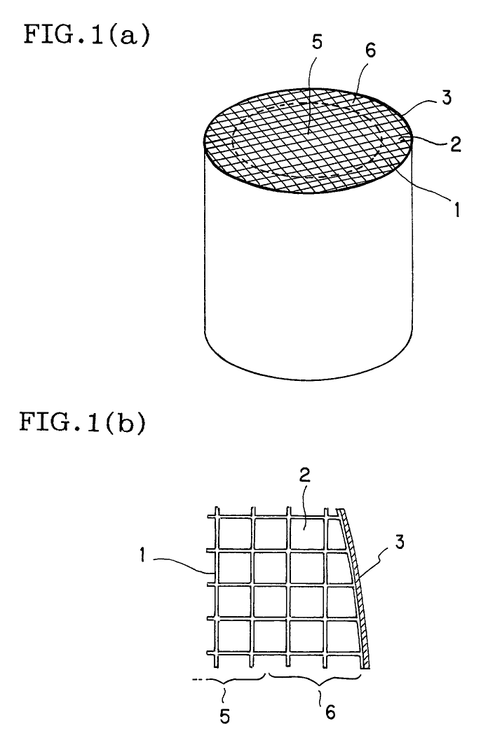

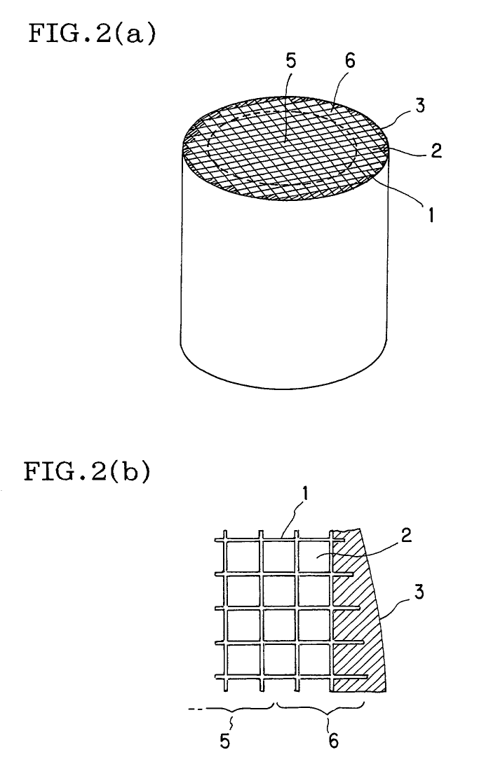

FIG. 1(a)(b) are schematic views describing one embodiment of a ceramic honeycomb structure whose outer circumferential wall portion was reinforced in the present invention, and FIG. 2(a)(b) show one embodiment of a ceramic honeycomb structure whose outer circumferential wall portion was reinforced after the grinding removal in the present invention. FIG. 1(a) and FIG. 2(a) are perspective views, and FIG. 1(b) and FIG. 2(b) are enlarged views around the reinforced outer circumferential wall portion, respectively.

As FIGS. 1(a) and 1(b) show, in the present invention, a ceramic honeycomb structure has a plurality of through-holes (cells) 2 surrounded by partition walls 1. A thermal expansion coefficient in an outer circumferential wall portion 3 is made larger than that of an inside partition wall portion 5 in a direction of a diameter of the ceramic honeycomb structure. The ceramic honeycomb structure is in the state that stress is applied to the inside partition wall portion 5 from the outer circumferential wall portion 3.

In a ceramic honeycomb structure having such a constitution, after the ceramic honeycomb structure having a plurality of through-holes (cells 2) surrounded by partition walls 1 is first prepared, a raw material which becomes cordierite when it is fired is slurried and applied to a circumferential portion of the ceramic honeycomb structure to form the outer circumferential wall portion 3. Subsequently, the ceramic honeycomb structure is fired to make the thermal expansion coefficient of the outer circumferential wall portion 3 of a ceramic honeycomb structure larger than that of the inside partition wall portion 5 in a direction of a diameter of a ceramic honeycomb structure to put the ceramic honeycomb structure in the state that stress is applied to the inside partition wall portion 5 from the outer circumferential wall portion 3.

In addition, as shown in FIGS. 2(a) and 2(b), after an outer circumferential partition wall portion 6 of a ceramic honeycomb structure having cells 2 partitioned off by partition walls 1 was removed by being ground, a raw material which becomes cordierite when it is fired is slurried and applied to form the outer circumferential wall portion 3 and fired, thereby a thermal expansion coefficient of the outer circumferential wall portion 3 of a ceramic honeycomb structure is made larger than that of the inside partition wall portion 5 in a direction of a diameter of the ceramic honeycomb structure to put the ceramic honeycomb structure in the state that stress is applied to the inside partition wall portion 5 from the outer circumferential wall portion 3.

A basic principle and function of the present invention are described hereinbelow. In the case that a raw material of the cordierite, which is a general raw material for a honeycomb structure, is subjected to extrusion forming to form a honeycomb structure, a kaolin crystal having a hexagonal planar shape is oriented along a face of the partition walls 1 when it passes through a narrow slit. In the later firing step, a cordierite crystal having a hexagonal pillar shape is generated perpendicularly to the kaolin crystal. A thermal expansion coefficient of the cordierite crystallization is different depending on directions, that is, +2.9×10⁻⁶/° C. in a direction of a diameter and −1.1×10⁻⁶/° C. in a longitudinal direction. Therefore, the honeycomb structure subjected to extrusion forming and fired has a thermal expansion coefficient which is obtained by synthesizing +2.9 and −1.1 (in fact, about 0.6×10⁻⁶/° C.) in a direction of a through-hole and a diameter and +2.9×10⁻⁶/° C. in a direction of a thickness of a partition wall.

If a raw material which becomes the same cordierite is slurried and applied to the outer circumferential wall portion 3 of a ceramic honeycomb structure as shown in FIG. 1(a)(b) and FIG. 2(a)(b) and the ceramic honeycomb structure is fired by making use of such a characteristic of a cordierite crystallization, a thermal expansion coefficient of the outer circumferential wall portion 3 where the slurry was applied is about 2×10⁻⁶/° C. because kaolin is not oriented in the portion. Further, if this thermal expansion coefficient is about 1×10⁻⁶/° C. or more, the thermal expansion coefficient is adjustable by a combination of a raw material which becomes cordierite by being fired and other raw material, and it can be appropriately adjusted from a relation between a cell structure and a thermal expansion coefficient of the inside partition wall portion 5.

Incidentally, a slurried raw material to be applied to form the outer circumferential wall portion 3 may be a material which becomes cordierite when it is fired, that is the same as a raw material for a ceramic honeycomb structure, or may be another material. That is, it may be appropriately chosen among alumina, silicon nitride, aluminum titanate, mullite, and materials which become these when they are fired, and a slurried material may be prepared by combining these. Therefore, a thermal expansion coefficient of the outer circumferential wall portion 3 can be adjusted in a moderate value from the relation with a thermal expansion coefficient of the inside partition wall portion 5.

In the stage of subjecting a raw material of cordierite to extrusion forming in order to give a honeycomb shape, raw material particles are merely placed in line. However, when temperature rises and reaches a firing temperature, cordierite is generated, and crystals melt to be united. In the later cooling process, the outer circumferential wall portion 3 having a large thermal expansion coefficient is in the state that it shrinks more than the inside partition wall portion 5 having a small thermal expansion coefficient. That is, the ceramic honeycomb structure of the present invention is in the state that a compression effect can be obtained from outside.

In addition, cordierite is preferably applied as a material constituting a ceramic honeycomb structure in view of its low thermal expansion property as described above. However, it is not limited to cordierite, and another raw material such as alumina may be employed depending on its use.

When hot exhaust gas is suddenly sent in an automobile exhaust gas purification apparatus in which a ceramic honeycomb structure is arranged, a difference in temperature between in a central portion and in an outer circumferential portion is generated, and a thermal shock is applied to the ceramic honeycomb structure. The central portion of the ceramic honeycomb structure becomes hot and is going to expand at this time. However, it cannot expand because the outer circumferential portion is at normal temperature. Therefore, internal pressure is applied, and a tensile load is applied to the outer wall. Generally, ceramics is relatively weak against a tensile load though it is strong against compression load. Therefore, in the case that a tensile load in an outer circumferential portion due to temperature distribution exceeds rupture strength of a ceramic honeycomb structure, the ceramic honeycomb structure is ruptured. To the contrary, in the ceramic honeycomb structure where the outer circumferential wall portion 3 is subjected to the specific reinforcement of the present invention, a thermal expansion coefficient of the outer circumferential wall portion 3 is larger than that of the inside partition wall portion 5 in a direction of a diameter. In other wards, the outer circumferential wall portion 3 is in a compressed state, and stress is applied toward the inside partition wall portion 5. That is, since a tensile load is not applied until a tensile load larger than this stress is applied, the outer circumferential wall portion 3 in a compressed state like the present invention have a weaker outbreak tensile load in comparison with an outer circumferential wall portion of a normal ceramic honeycomb structure, thereby thermal shock resistance is increased, and rupture is hard to be caused.

Further, the present invention can be preferably applied to a ceramic honeycomb structure having thin walls, which has a thickness of a partition wall of 0.1 mm or less and 62 cells/cm² or more, or an open frontal area of 86% or more, or a bulk density of 0.26 g/cm³. In addition, when a ceramic honeycomb structure having such thin walls is produced, deformation of a partition wall near the outer circumferential wall portion is often caused. However, in such a deformed ceramic honeycomb structure, the outer circumferential wall portion having excellent thermal shock resistance can be newly formed by grinding and removing a deformed portion. By this, it is possible to produce a ceramic honeycomb structure having a large surface area per unit volume and a strength by which the structure can stand practical use and to anticipate improvement of production yield.

### [EXAMPLES]

A specific result of operation of the present invention is hereinbelow described.

### (Examples 1-5, Comparative Examples 1-10)

A raw material which becomes cordierite when it is fired was subjected to extrusion forming and fired to produce 30 cordierite honeycomb structures each having an outer diameter of 106 mm, a full length of 114 mm, a thickness of partition walls as shown in Table 1 (sample No. 1-7), 62 cells/cm², and a thickness of the outer circumferential wall portion of 0.25 mm in each kind. Ten out of these cordierite honeycomb structures in each kind of samples were taken out. The same raw material was slurried as shown in FIGS. 1(a) and 1(b) and applied on the outer circumferential wall portion to have a thickness of about 1.25 mm. Then, the cordierite honeycomb structures were fired to give Examples 1 to 5. Other ten cordierite honeycomb structures were not processed at all for Comparative Examples 1 to 5. As for the other ten, in accordance with a method disclosed in Japanese Patent Laid-Open No. 57-99340, a solution including 10% by weight of α-alumina was passed through a portion having a thickness of 30 mm from the outer circumferential wall portion, surplus liquid was blown off with compressed air to dry the structures, the solution was passed through a portion having a thickness of 15 mm from the outer circumferential wall portion, and they were dried and fired to give Comparative Examples 6 to 10.

TABLE 1

| | Naming | Thickness of | Number | Open frontal | Bulk |
|---|---|---|---|---|---|
| Sample | of cell | partition wall | of cells | area | density |
| No. | structure | (mm) | (cells/cm²) | (%) | (g/cm³) |
| 1 | 3/400 | 0.076 | 62 | 88 | 0.21 |
| 2 | 3.5/400 | 0.089 | 62 | 87 | 0.24 |
| 3 | 4/400 | 0.102 | 62 | 85 | 0.27 |
| 4 | 5/400 | 0.127 | 62 | 81 | 0.33 |
| 5 | 7/400 | 0.170 | 62 | 75 | 0.43 |
| 6 | 2.5/900 | 0.064 | 140 | 86 | 0.26 |
| 7 | 2/1200 | 0.051 | 186 | 87 | 0.24 |

A ceramic mat was wound up around the outer circumference of each of three kinds of the above cordierite honeycomb structures, each of which was pressed in a can, and a cone was attached to the can to produce a converter. Combustion gas of propane gas was sent into the converter, and a thermal shock test was conducted. The temperature of the combustion gas was 800° C. at a position of the 10 mm front from the honeycomb front face. The gas was sent with a gas flow rate of 3 Nm³/min for five minutes before air at room temperature was sent for five minutes, which was regarded as 1 cycle, and each honeycomb structure was taken out after 10 cycles to check presence or absence of a crack. When no crack was found, temperature of 50° C. combustion gas was raised, and the above operation was repeated in the same manner till a crack occurs. Five of each kind were tested. The results are shown in Table 2. In addition, samples of 50 mm long was cut off in a right-angled triangle section of 3.5 mm and in a 3.5 mm square section from a central portion so that the outer circumferential wall portion may become an oblique side. Two of each kind of samples were measured for thermal expansion coefficient. The results are shown in Table 2.

Incidentally, prior to the thermal shock test, the tip of the corn of each converter was connected to a blower to send air at room temperature at the rate of 6 m³/min., and a difference in pressure (a pressure drop) between in front and at the back of the honeycomb structure was measured. The results are shown in Table 2. Since Comparative Examples 1 to 5 has completely the same honeycomb portion as Examples 1 to 5 and, therefore, has the same pressure drop at this time, the test was omitted except for the sample No. 1 (cell structure naming: 3/400).

In addition, about the sample No. 2 (naming of cell structure: 3.5/400), a sample carrying 0.2 g/cm³ of γ-alumina was prepared after the model of a catalyst, and the sample was attached to a converter. Air at room temperature was sent to the converter at a rate of 3 m³/min. A flow speed in a fine portion was measured at a 10 mm-backward position from an exit end face of the honeycomb structure. The results are shown in Table 3. In the measurement, a hot-wire anemometer of a resistance-exothermic type having a width of the tip of a probe of about 3 mm was used.

TABLE 2

| | Kind | | Thermal | Thermal expansion coefficient (10⁻⁶/° C.) | | | |
|---|---|---|---|---|---|---|---|
| | Naming of | Example or | shock | Outer | | | Pressure |
| Sample | cell | Comparative | test | circumferential | Intermediate | Central | loss |
| No. | structure | Example | (° C)*² | wall portion | portion*¹ | portion | (mmAq) |
| 1 | 3/400 | Example 1 | 900 | — | — | — | 586(100%) |
| | | Comp. Ex. 1 | 830 | — | — | — | 588(100%) |
| | | Comp. Ex. 6 | 790 | — | — | — | 639(109%) |
| 2 | 3.5/400 | Example 2 | 930 | 1.83, 1.81 | 0.40, 0.46 | 0.40, 0.46 | 609(100%) |
| | | Comp. Ex. 2 | 870 | 0.33, 0.46 | 0.35, 0.46 | 0.35, 0.46 | — |
| | | Comp. Ex. 7 | 820 | 1.80, 1.85 | 1.29, 1.33 | 0.35, 0.46 | 660(108%) |
| 3 | 4/400 | Example 3 | 890 | — | — | — | 633(100%) |
| | | Comp. Ex. 3 | 860 | — | — | — | — |
| | | Comp. Ex. 8 | 830 | — | — | — | 691(109%) |
| 4 | 5/400 | Example 4 | 890 | — | — | — | 685(100%) |
| | | Comp. Ex. 4 | 870 | — | — | — | — |
| | | Comp. Ex. 9 | 860 | — | — | — | 753(109%) |
| 5 | 7/400 | Example 5 | 880 | 1.68, 1.70 | 0.42, 0.44 | 0.41, 0.45 | 786(100%) |
| | | Comp. Ex. 5 | 870 | 0.42, 0.45 | 0.40, 0.44 | 0.39, 0.43 | — |
| | | Comp. Ex. 10 | 860 | 1.77, 1.79 | 1.53, 1.58 | 0.37, 0.43 | 882(111%) |

Note:
*¹Intermediate portion is in the range of 15-30 mm from outer circumference.
*²Average of rupture of 5 samples

TABLE 3

| | Kind | | Flow rate (m/s) | | | | | | |
|---|---|---|---|---|---|---|---|---|---|
| Sample | Naming of | Example or | | | | | | | 0 mm |
| No. | cell structure | Comp. Ex. | Site | 50 mm | 40 mm | 30 mm | 20 mm | 10 mm | (Center) |

| | | | | | | | | |
|---|---|---|---|---|---|---|---|---|
| 2 | 3.5/400 | Example 1 | 10.8 | 12.4 | 19.5 | 26.6 | 30.8 | 32.0 |
| | | Comp. Ex. 2 | 1.7 | 1.7 | 3.8 | 8.1 | 41.0 | 54.3 |

### (Example 6, Comparative Example 11)

The same raw material which becomes cordierite when it is fired was subjected to forming and fired to obtain 20 cordierite honeycomb structures, each having a full length of 114 mm, a thickness of a partition wall of 0.05 mm, and 186 cells/cm². Ten among them were ground by a grinder having a diamond grinding stone so that the outer diameter of 118 mm after firing was reduced up to the outer diameter of 105 mm. The same raw material was slurried and applied to the cordierite honeycomb structures to form the outer circumferential wall portion as shown in FIGS. 2(a) and 2(b). The cordierite honeycomb structures were fired again to give “Example 6” having an outer diameter of 106 mm. A thickness of the outer circumferential wall portion at this time was not uniform, a reason of which is that the outer circumferential portion partition wall after being ground has a form of the teeth of a comb, and the average was about 1.7 mm. The other ten were employed as “Comparative Example 11”. At this time, the outer diameter was 106 mm, and the thickness of the outer circumferential wall was 0.2 mm. Seven of each kind were subjected to the aforementioned thermal shock test and measured for thermal expansion coefficient. The results are shown in table 4.

TABLE 4

| | | | Thermal expansion coefficient | |
|---|---|---|---|---|
| | Thermal shock test (° C.) | | (10⁻⁶/° C.) | |
| | Average | | Outer | |
| | of | | circumferential | Central |
| Kind | rupture | Range | wall portion | portion |
| Example 6 | 880 | 850-900 | 1.60, 1.67 | 0.38, 0.44 |
| Comp. Ex. 11 | 810 | 750-850 | 0.35, 0.41 | 0.35, 0.43 |

In addition, an aluminum board is abutted against an individual end face of two kinds of the aforementioned cordierite honeycomb structures of Example 6 and Comparative Example 11 by means of an urethane sheet having a thickness of about 0.5 mm, and the side was wrapped in a tube having a thickness of about 0.5 mm to be sealed up. They were put in a hydraulic container, and water pressure was raised by degrees till a sound of rupture could be heard to rupture the samples. Pressures at this time are shown in Table 5. Incidentally, the number of the tested samples is three in each Example.

TABLE 5

External
pressure strength test (MPa)

| | Average of | |
|---|---|---|
| Kind | rupture | Range |
| Example 6 | 1.21 | 1.03-1.52 |
| Comp. Ex. 11 | 0.55 | 0.45-0.62 |

(Study)

As is apparent from the above results, any Example of the present invention showed a dominant value in the thermal shock test and an external pressure strength test in comparison with Comparative Examples, and a superior effect of the present invention could be confirmed.

As discussed above, in the ceramic honeycomb structure whose outer circumferential wall portion was subjected to a specific reinforcement of the present invention, a pressure drop is not increased, a flow of gas is not abnormally concentrated in the center, and thermal shock resistance is improved. In addition, about the ceramic honeycomb structure having a thin partition wall and a wide surface area per unit volume, a product having excellent thermal shock resistance can be provided likewise, which is useful when it is used for an automobile exhaust gas purification apparatus, or the like, having relatively severe use conditions.

What is claimed is:

1. A ceramic honeycomb structure comprising a plurality of through-holes surrounded by partition walls, wherein a thermal expansion coefficient of an outer circumferential wall portion in the ceramic honeycomb structure is larger than a thermal expansion coefficient in a direction of a diameter of an inside partition wall portion in the ceramic honeycomb structure, and stress is applied to the inside partition wall portion from the outer circumferential wall portion.

2. A ceramic honeycomb structures as defined in claim 1, wherein a material for the outer circumferential wall portion of the ceramic honeycomb structure is the same as or different from a material for the ceramic honeycomb structure.

3. A ceramic honeycomb structure as defined in claim 1, wherein a partition wall of the ceramic honeycomb structure has a thickness of less than 0.1 mm.

4. A ceramic honeycomb structure as defined in claim 1, wherein the ceramic honeycomb structure has 62 cells/cm² or more.

5. A ceramic honeycomb structure as defined in claim 1, wherein the outer circumferential wall portion is thicker than an inside partition wall portion of the ceramic honeycomb structure.

6. A ceramic honeycomb structure as defined in claim 1, wherein the ceramic honeycomb structure has an open frontal area of 86% or more.

7. A ceramic honeycomb structure as defined in claim 1, wherein the ceramic honeycomb structure has a bulk density of 0.26 g/cm³ or less.
